(19) United States
(12) Patent Application Publication
(10) Pub. No.: US 2008/0152876 A1
(43) Pub. Date: Jun. 26, 2008

(54) Veneer Filling and Repair Method and Composition

(76) Inventors: Tryggvi Magnusson, Wausau, WI (US); Guenther Pollak, Mosinee, WI (US)

Correspondence Address: BOYLE FREDRICKSON S.C., 840 North Plankinton Avenue, MILWAUKEE, WI, 53203, US

(21) Appl. No.: 11/959,976

(22) Filed: Dec. 19, 2007

Related U.S. Application Data
(60) Provisional application No. 60/876,014, filed on Dec. 21, 2006.

(51) Int. Cl. B32B 3/10; B32B 43/00; C08F 2/46

(52) U.S. Cl. 428/195.1; 427/140; 522/1

(57) ABSTRACT

The present invention is filler composition and a method for applying the filler composition to an engineered hardwood flooring board in order to fill the defects in the veneer layer of the board to provide the desired appearance to the exterior of the board. The filler composition is applied continuously to a veneer layer forming the exterior surface of an engineered hardwood flooring board in a manner such that all defects and cracks in the veneer layer are filled with the filler composition. After application, the excess filler composition is removed from the board such that only the filler composition filling the defects in the veneer layer remains on the board.

### CROSS-REFERENCE TO RELATED APPLICATIONS

This application claims priority from U.S. Provisional Application Ser. No. 60/876,014, filed on Dec. 21, 2006, and incorporated herein in its entirety.

### FIELD OF THE INVENTION

The present invention relates generally to hardwood boards, and more specifically to a method of repairing veneers utilized in the manufacture of engineered hardwood flooring boards.

### BACKGROUND OF THE INVENTION

In manufacturing engineered hardwood boards, oftentimes a number of different plies of material are secured to one another in order to form the board. This enables the resulting board to be formed with the desired characteristics, e.g., thickness, width and length, for the particular use to which the board is put. The layers or plies of material utilized to form the engineered boards are normally selected from wood types that are not often utilized for their appearance, such as particle board or plywood. This is because these types of wood products are highly inexpensive in comparison to those type of wood that have a desirable exterior appearance, such as various types of hardwoods, including, but not limited to, mahogany, walnut, cherry, and oak.

In order to provide the desired aesthetic appearance to the exterior surface of the board formed from one or more plies or layers of these non-hardwood, wood materials, a thin veneer of a wood having the desired appearance is applied to the uppermost exposed ply or layer of the board. However, the veneer layer is typically formed of a thin section of the source wood selected for the board that is obtained by any of a number of conventional means that slice the thin layer off of one of the exposed surfaces of a piece of the source wood having the desired appearance. However, in the process for obtaining this thin slice, often times the edges of the veneer layer become cracked as a result of stresses applied to the veneer layer during the process for obtaining the veneer from the selected piece of source wood. These cracks greatly detract form the aesthetic appearance of the board, and can propagate through the veneer under certain environmental conditions, causing even further damage to the appearance of the veneer layer. Thus, these cracks formed during the process for obtaining the veneer must be filled or repaired prior to installation of the board to prevent any readily apparent defects from being visible in the resulting board.

As a result, it is desirable to develop a composition and process for utilizing the composition that is capable of quickly and easily repairing or filling the cracks formed in a veneer layer during the process for obtaining the veneer from the source wood. The composition and process for use should allow for the manufacture of engineered hardwood flooring boards in a manner that allows the veneers present on the exterior surface of the boards to have a desired appearance across the entire surface of the board.

### SUMMARY OF THE INVENTION

According to one aspect of the present invention, a putty composition and a method of applying the composition to an engineered flooring board to conceal defects in veneer layers on the board to provide flooring boards with the desired appearance is provided. The composition is formed of a curable material that can be easily spread into the cracks present in the veneer layer in the associated method to completely fill the defects or cracks in the veneer layer. Once filled, the filler material or putty composition can be cured in a suitable manner, and the board can be further processed to obtain the desired appearance for the board in accordance with the appearance of the hardwood of which the veneer layer is formed.

According to another aspect of the present invention, the process for applying the composition to the veneer layer to fill the cracks in the layer effectively spreads the composition across the veneer layer and into the crack present therein. Also, the process enables the excess filler composition to be almost entirely removed from the board after filling the cracks in the veneer layer and prior to being cured by air, UV light or in any other suitable manner, such that essentially all of the filling composition remaining on the veneer layer of the board is positioned within the defects or cracks in the veneer layer.

Numerous other aspects, features and advantages of the present invention will be made apparent from the following detailed description taken together with the drawing figures.

### BRIEF DESCRIPTION OF THE DRAWINGS

The drawings illustrate the best mode currently contemplated as practicing the present invention.

In the drawings:

FIG. 1 is a cross-section of a board including a number of defects in a veneer layer that have been repaired utilizing the method of the present invention;

FIG. 2 is a flow chart illustrating the steps of the method of the present invention; and

FIG. 3 is a schematic view of an apparatus utilized in the method of the present invention.

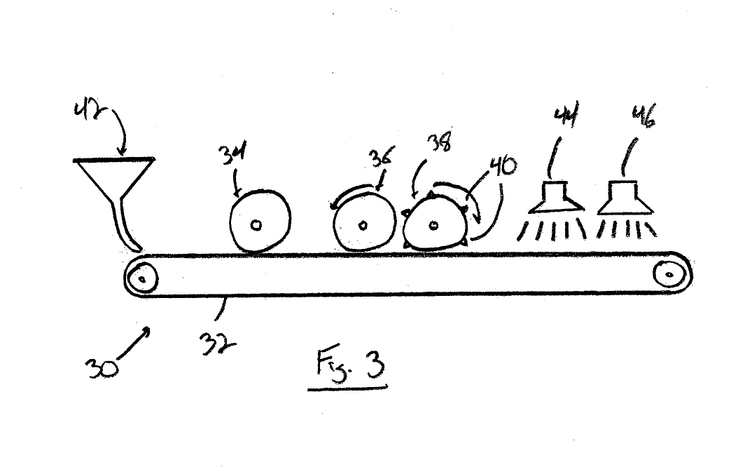

### DETAILED DESCRIPTION OF THE INVENTION

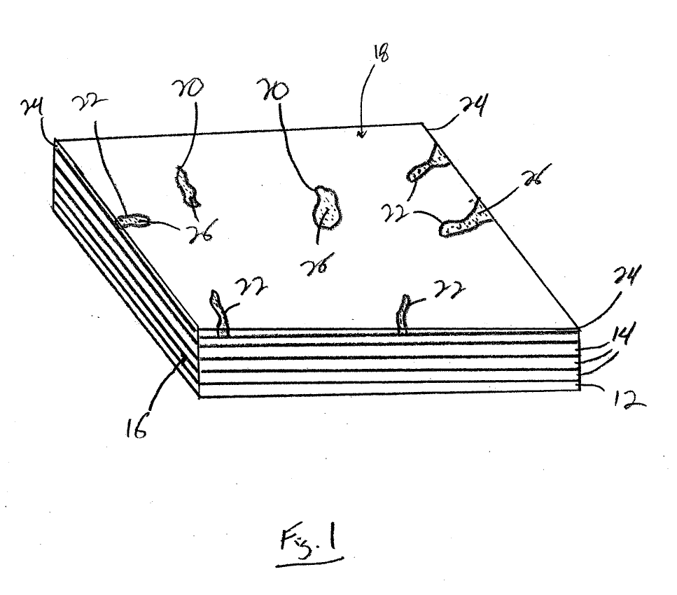

With reference now to the drawing figures in which like reference numerals designate like parts throughout the disclosure, a board constructed according to the present invention is illustrated generally at 10 in FIG. 1. The board 10 includes a bottom layer 12, a number of inner layers 14 forming a core 16 for the board 10, and an upper veneer layer 18. The bottom layer 12 and the inner layers 14 forming the core 16 can be formed from any suitable wood materials, such as particle board or plywood, among other, or even from any suitable non-wood materials, such as an extruded plastic material. The materials selected for forming the bottom layer 12 and the inner layers 14 have a sufficient rigidity and density to provide the board 10 with a shape and feel similar to a board formed entirely from a hardwood whose appearance the board 10 is designed to mimic. Also, each of the bottom layer and the inner layers 14 are affixed to one another in any suitable manner, such as by using a suitable adhesive or mechanical fastener, to retain the layers 12 and 14 in the desired shape for the board 10.

The upper layer 18 is obtained from a piece of source wood selected to provide the desired appearance for the board 10. The veneer layer 18 is formed utilizing any suitable method, such as by cutting strips of the source wood from the wood piece to function as the veneer layer 18. The veneer layers 18 can be treated in order to ensure the veneer layers 18 are relatively flat prior to application to the core 16 opposite the bottom layer 12 to form the board 10. The veneer layer 18 is affixed to the upper surface of the core 16 using means similar to that used to secure the layers 12 an 14 to one another, such as a suitable adhesive or a mechanical fastener, among others.

During the process for obtaining the veneer layer 18 from a piece of source wood, the veneer layer 18 often has a number of defects 20 formed within the layer 18 by the apparatus separating the veneer layer 18 from the source wood that can take the form of holes, depressions, or gouges, among others. Additionally, the layer 18 can lose moisture and dry out after being separated from the source wood. As a result, the veneer layer 18 can become brittle, and a number of cracks 22 can form in the edges 24 of the veneer layer 18. To provide the desired appearance for the entire exposed surface of the board 10, these defects 20 and cracks 22 must be repaired in manner that can effectively present a smooth and uniform surface on the veneer layer 18.

To repair the defects 20 and cracks 22, after an optional initial light sanding step performed on the veneer layer 18, a filler composition 26 is applied to the exposed surface of the veneer layer 18 to fill the spaces in the veneer layer 18 formed by the defects 20 and cracks 22. The filler composition 26 can be applied in any suitable manner, such as along the direction of the grain in the veneer layer 18 or at an angle with regard to the veneer grain direction. Additionally, the application of the filler composition 26 to the veneer layer 18 can be performed manually, or automatically by a suitable apparatus capable of relatively evenly spreading the filler composition 26 across the entire surface of the veneer layer 18.

The filler composition 26 is formed primarily, i.e., from 75% to 100% w/w, of one or more of polyurethane acrylate (aromatic or aliphatic), epoxy acrylate, polyester acrylate, polyether acrylates, or other polymers formed with suitable acrylic monomers, polyisocyanates (aliphatic or aromatic). Additional components that can be included in the filler composition 26 include filling agents, such as inorganic oxides and fumed silica, in an amount of between 0% to 5% w/w, suitable photo-initiators, such as Irgacure® 819 that respond well to UV radiation of 360-420 nm (typical emission of gallium lamps) and photo-initiators such as benzophenone or Irgacure® 1173/Irgacure® 1000/Irgacure® 184 and their blends that respond well to UV radiation of 280-360 nm (typical emission of mercury lamps) in an amount of between 0% to 5% w/w, optionally pigments (organic or inorganic) in an amount of between) 5 to 2% w/w, and optionally an amine used as a thickener in an amount of between 0% to 2% w/w. These components are mixed together in any suitable manner an in any order to achieve the filler composition 26 of the present invention.

In a preferred embodiment of the method of the present invention, in order to provide an appropriate and practical method to fill the defects 20 or cracks 22 in the veneer layer 18, a suitable application apparatus (not shown) such as those which are well known and widely used in the field of wood coatings can be utilized. In particular, the filler composition 26 is applied with machine that is known as a “heavy duty” filling machine in order to effectively fill each of the defects 20 and cracks 22 with the filler composition 26. A suitable machine 30 includes the following components for proper application of the filler composition 26:

a. a conveyor belt 32 (variable speed).

b. a chrome plated doctor roller 34 (variable speed, direction and variable position to application roller 36 to define and adjust the amount of filler composition 26 applied by the application roller 36)

c. a rubber coated application roller 36 (variable speed and variable position to conveyor belt 32) that rotates in the direction of conveyor (forward) and applies excess amount of filler to the entire board.

d. a chrome plated smoother roller 38 (variable speed and variably positionable with respect to conveyor (a) and application roller (c)) that rotates against conveyor direction (reverse) and removes excess filler composition 26 from the entire board 10 and fills/pushes the filler composition 26 into the defects 20 and/or cracks 22.

e. a doctor blade 40 attached to smoother roller 38 that removes excess filler composition 26 from the smoother roller 38 and transfers the excess filler composition back to the application roller 36.

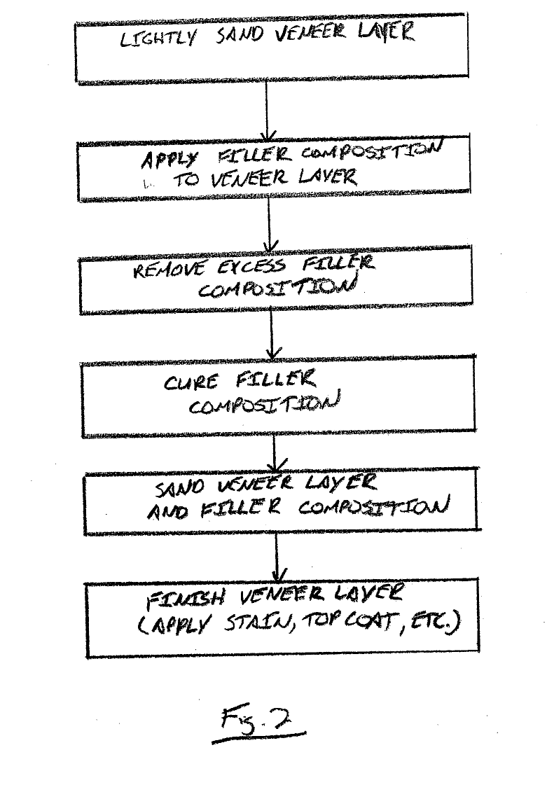

As shown in flowchart of FIG. 2 illustrating the method, the machine 30 including these features is used to dispense the filler composition 26 from a suitable reservoir 42 onto the veneer layer 18 of the board 10 passing through the machine 30 and effectively fill the defects 20 and cracks 22 present in the veneer layer 18 on the board 10.

The preferably UV-curable filler composition 26 of the present invention is applied over the entire exposed surface of the veneer layer 18 on the board 10 utilizing the machine 30 described above. After application and removal of the excess filler composition 26 from the veneer layer 18, the filler composition 26 remaining within the defects 20 and the cracks 22 is cured with 2 UV light sources 44, 46, the first being a UV lamp 44 dotted with gallium for curing the bottom of the applied wet layer of the filler composition 26, and the second being a UV lamp 46 dotted with mercury for curing of the top of the wet layer of the filler composition 26.

Depending on the size of the particular defect 20 or crack 22, the application and curing steps outlined above can be repeated in order to apply sufficient filler composition 26 to the veneer layer 18 to provide the desired exterior appearance for the board 10.

After application and curing of the filler composition 26 within the various defects 20 and cracks 22, the veneer layer 18 is sanded, preferably slightly for a rough calibration to avoid discoloration and excess consumption of UV filler composition 26. More particularly, once the veneer layer 18 is repaired and the void 20 or crack 22 within the veneer layer 18 is filled with the composition 26, any remaining excess applied and cured filler composition 26 is removed from the board 10 entirely by a regular calibration sanding process and remains only in the defective areas 20, 22 of the veneer layer 18. After sanding to remove the excess cured filler composition 26, the board 10 can be stained and covered with a top coat (not shown) to provide the board 10 with the desired finished appearance.

Various alternatives are contemplated as being within the scope of the following claims particularly pointing out and distinctly claiming the subject matter regarded as the invention.

What is claimed is:

1. A method for repairing defects in a surface of a flooring board, the method comprising the steps of:
a) providing an amount of a filler composition;
b) applying an excess amount of the composition to the surface of the board including the defects to fill the defects with the composition; and
c) removing the excess composition from the surface.

2. The method of claim 1 further comprising the step of curing the filler composition after removing the excess composition from the surface.

3. The method of claim 1 further comprising the step of curing the filler composition prior to removing the excess composition from the surface.

4. The method of claim 1 wherein the step of removing the excess composition from the surface comprises sanding the excess composition off of the surface.

5. The method of claim 1 wherein the step of removing the excess composition from the surface comprises scraping the excess composition off of the surface.

6. The method of claim 1 wherein the filler composition is UV-curable.

7. The method of claim 1 wherein the step of applying the composition comprises applying the composition along a grain direction of the board.

8. The method of claim 1 wherein the step of applying the composition comprises applying the composition at an angle with respect to a grain direction of the board.

9. A flooring board having a veneer layer formed by the process of:
a) providing an amount of a filler composition;
b) applying an excess amount of the composition to the veneer layer of the board including defects to fill the defects with the composition; and
c) removing the excess composition from the veneer layer.

10. The board of claim 9 wherein the filler composition includes a light-curable resin filler, a filling agent, a photo-initiator, and optionally a thickener.

11. The board of claim 10 wherein the filler is selected from the group consisting of: polyurethane acrylate, epoxy acrylate, polyester acrylate, polyether acrylates, polymers including acrylic monomers, and polyisocyanates.

12. The board of claim 10 wherein the filling agent is selected from the group consisting of: inorganic oxides and fumed silica.

13. A filler composition for use in filling and repairing defects and cracks in a veneer layer of an engineered flooring board, the composition comprising:
a) a resin filler;
b) a filling agent;
c) a photo-initiator;
d) optionally a thickener; and
e) optionally a pigment.

14. The filler composition of claim 13 wherein the resin filler is light-curable.

15. The filler composition of claim 14 wherein the resin filler is selected from the group consisting of: polyurethane acrylate, epoxy acrylate, polyester acrylate, polyether acrylates, polymers including acrylic monomers, and polyisocyanates.

16. The filler composition of claim 14 wherein the filling agent is selected from the group consisting of: inorganic oxides and fumed silica.
